(19) United States
(12) Patent Application Publication
(10) Pub. No.: US 2025/0166945 A1
(43) Pub. Date: May 22, 2025

(54) LABEL ACCESS MECHANISMS FOR ROCKER SWITCH

(71) Applicant: LUEMELIT LLC, Brooklyn Park, MN (US)

(72) Inventor: Melissa Zuniga, Brooklyn Park, MN (US)

(21) Appl. No.: 18/840,891

(22) PCT Filed: Feb. 22, 2023
(86) PCT No.: PCT/US2023/063024

§ 371 Date: Aug. 22, 2024

Related U.S. Application Data
(60) Provisional application No. 63/268,347, filed on Feb. 22, 2022.

(51) Int. Cl. H01H 23/02; H01H 9/16

(52) U.S. Cl. CPC H01H 23/025; H01H 9/161; H01H 2009/164; H01H 2219/004; H01H 2219/062

(57) ABSTRACT

Electrical switches with label access mechanisms. In one aspect, a rocker switch with a translucent cover presents an elongated aperture, or slot, for insertion or removal of a label. In embodiments, the slot is arranged on an upper, or top surface of the cover, or on a side surface of the cover. In embodiments, more than one slot is provided. A hinge is provided on the cover of a rocker assembly, the hinge enabling the cover to rotate relative to the rocker assembly for access, insertion, and removal of interchangeable labels.

### RELATED APPLICATION

The present application claims the benefit of U.S. Provisional Application No. 63/268,347 entitled “LABEL ACCESS MECHANISMS FOR ROCKER SWITCH”, filed Feb. 22, 2022, which is incorporated herein by reference in its entirety.

### TECHNICAL FIELD

Embodiments of the present disclosure relate generally to the field of electrical switches, specifically electrical switches adapted for use in building wiring.

### BACKGROUND

In many building environments, lights, electrical outlets, and other devices are controlled by a series of electrical switches, often referred to as “light switches.” For convenience, these switches are often arranged on panels with two or more switches in close proximity. Individual switches on panels are often generic, leading to user confusion regarding which electrical device(s) are controlled by any particular switch.

A variety of labeling options for switch plates exist, ranging from permanently labeled plates to removable adhesive labels. However, in many environments, switch plate designs are decorative, and labels incorporated into switch plates can be intrusive.

A need exists therefore, for electrical switches that enable identification of the electrical device(s) and/or circuits that they are configured to control.

### SUMMARY OF THE INVENTION

Embodiments of the present disclosure provide rocker switches with mechanisms for inserting or accessing an internally stored label.

In one aspect of the present disclosure, a rocker switch with a translucent cover presents an elongated aperture, or slot, for insertion or removal of a label. In embodiments, the slot is arranged on an upper, or top surface of the cover. In embodiments, the slot is arranged on a side surface of the cover. In embodiments, more than one slot is provided.

In one aspect of the present disclosure, an electrical switch to control an electrical circuit comprises a rocker assembly pivotable between a first position and a second position, and a switch body. The rocker assembly comprises a light pipe arrangeable proximate a rear surface of the rocker assembly, a cover arrangeable proximate a front surface of the rocker assembly, a slot on a surface of the cover for insertion of an interchangeable label between the light pipe and the cover, and an illuminating element. The switch body comprises a first terminal for electrical connection to a first lead of the electrical circuit and a second terminal for electrical connection to a second lead of the electrical circuit.

In one aspect of the present disclosure, the cover is a cover couplable to the cover base through a hinge mechanism. In an embodiment, the hinge mechanism comprises a pin and knuckles and arrangeable proximate a front surface of the interchangeable label.

In one aspect of the present disclosure, a kit for providing an indication of a function of an electrical switch, the kit comprising includes a plurality of interchangeable labels, and an electrical switch. In embodiments, each of the plurality of interchangeable labels comprises a user-comprisable identifier on a front surface of the interchangeable label such that the interchangeable label indicates a property of the electrical circuit controlled by the electrical switch.

In one aspect, the invention may include an electrical switch to control an electrical circuit comprising:
a switch body including a first terminal for electrical connection to a first lead of the electrical circuit and a second terminal for electrical connection to a second lead of the electrical circuit;
   an interchangeable label arrangeable proximate a rear surface of the rocker, wherein the interchangeable label can comprise a label, sticker, decal, or other interchangeable decorative element and wherein the interchangeable label can be partially transparent or translucent;
   a light pipe arrangeable proximate a rear surface of the interchangeable label; wherein interchangeable label can be removably coupled to the light pipe via at least one adhesive surface;
   a plurality of illuminating elements; wherein each of the plurality of illuminating elements comprises a tri-color light-emitting diode (LED);
   a rocker assembly including a rocker, a light pipe arrangeable proximate a rear surface of the rocker assembly, a cover arrangeable proximate a front surface of the rocker assembly, a slot on a surface of the cover for insertion of the interchangeable label between the light pipe and the cover, and the illuminating elements; wherein
   the rocker is pivotable between a first position and a second position such that the electrical circuit is energized when the rocker is in the first position and deenergized when the rocker is in the second position;
   wherein the interchangeable label can be removably coupled to the cover via at least one adhesive surface;
   wherein the cover is couplable to the cover base through a hinge;
   wherein the cover comprises a transparent material and is arrangeable proximate the interchangeable label the light pipe when the electrical switch is in use; wherein the hinge comprises a pin and knuckles and arrangeable proximate a front surface of the interchangeable label;
   wherein a controller having electrical communication with each of the illuminating elements is configured to change a display state of at least one illuminating element of the plurality of illuminating elements in response to a signal received via a communication interface and wherein the communication interface comprises a wireless interface;
   wherein changing the display state of the at least one illuminating element comprises one or more of
      changing a color of the at least one illuminating element,
      changing a light intensity of the at least one illuminating element, or
      changing a flash rate of the at least one illuminating element;
   wherein the interchangeable label comprises a user-comprisable identifier on a front surface of the interchangeable label, such that the interchangeable label indicates a property of the electrical circuit controlled by the electrical switch;
   wherein a conductive trace electrically couples each illuminating element of the plurality of the illuminating elements to the electrical circuit controlled by the electrical switch, such that the illuminating element is powered by the electrical circuit;
   wherein a power source independent of the electrical circuit, such that the illuminating element is powered by the power source;
   wherein the interchangeable label at least partially comprises a light-transmitting material, such that a light generated by the illuminating element can be seen at a front surface of the interchangeable tile; and
   wherein any element of the rocker assembly can comprise a ferromagnetic material such that the interchangeable label is magnetically affixable within the rocker assembly.

In one aspect, the present invention may include a kit for providing an indication of a function of an electrical switch, the kit comprising:
a plurality of interchangeable labels;
an electrical switch to control an electrical circuit comprising;
   a switch body including a first terminal for electrical connection to a first lead of the electrical circuit and a second terminal for electrical connection to a second lead of the electrical circuit,
   a rocker pivotable between a first position and a second position such that the electrical circuit is energized when the rocker is in the first position and deenergized when the rocker is in the second position, the rocker defining an aperture,
   an illuminating element;
   a cover arranged within the aperture such that a front surface of the cover is viewable by a user;
   a light pipe, wherein each interchangeable label of the plurality of interchangeable labels is removably arrangeable between the cover and the light pipe; and
   wherein each of the plurality of interchangeable labels comprises a user-comprisable identifier on a front surface of the interchangeable label such that the interchangeable label indicates a property of the electrical circuit controlled by the electrical switch;

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1A is an exploded perspective view depicting a rocker switch, according to an embodiment.

FIG. 1B is a perspective view depicting components of the rocker switch of FIG. 1A.

FIG. 1C is an exploded perspective view depicting components of the rocker switch of FIG. 1A.

FIG. 2A is a front plant view depicting a rocker switch, according to an embodiment.

FIG. 2B is a side plan view depicting a rocker switch, according to an embodiment.

FIG. 3 is a perspective view depicting a rocker switch with a side slot, according to an embodiment.

FIG. 4 is a perspective view depicting a rocker switch with a top slot, according to an embodiment.

FIG. 5A is a perspective view depicting a rocker switch with a hinged cover, according to an embodiment.

FIG. 5B is a perspective view depicting components of the rocker switch of FIG. 5A.

FIG. 5C is a perspective view depicting components of the rocker switch of FIG. 5A.

FIG. 5D is a perspective view of the rocker switch of FIG. 5A.

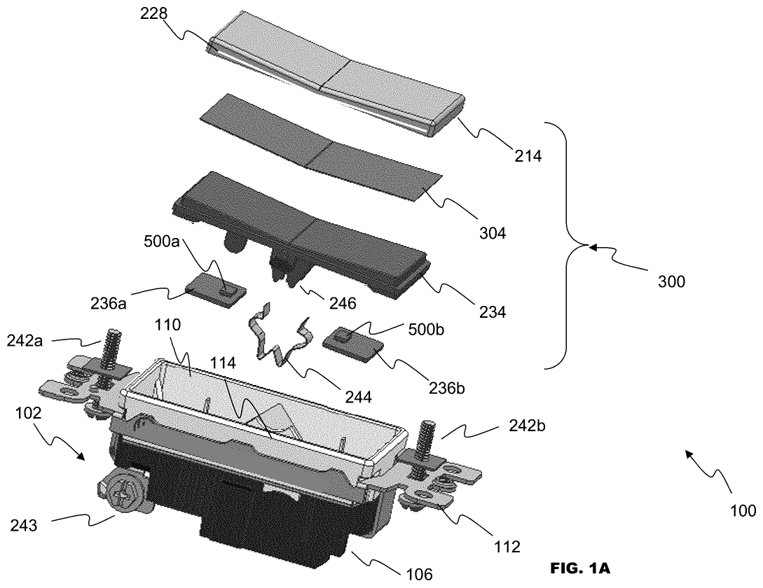

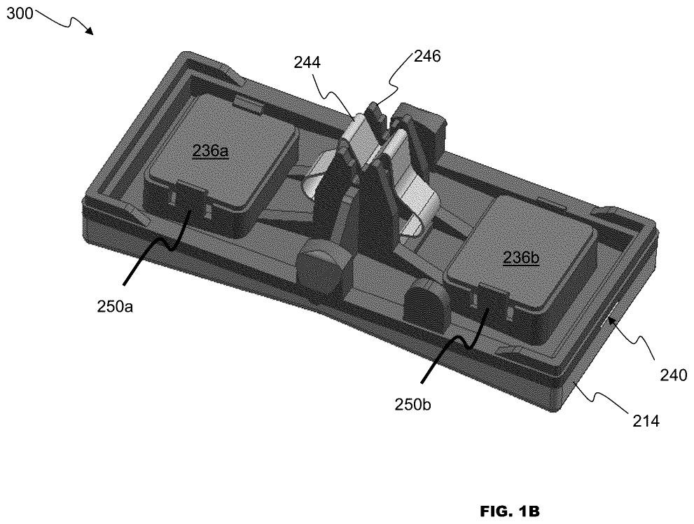

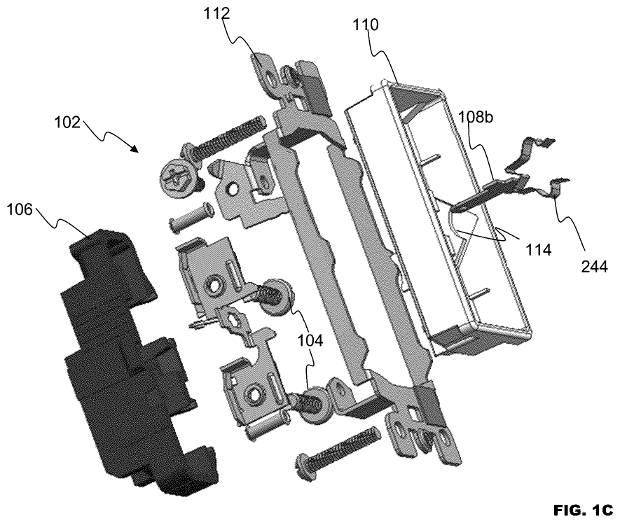

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

FIG. TA is a perspective view of an embodiment of an electrical switch 100. Electrical switch 100 can enable a user to control an electrical circuit via manipulation of rocker assembly 300. In embodiments, the electrical circuit can include one or more lighting devices, electrical outlets, other devices, or combinations of these. Various embodiments of switches, rockers, rocker assemblies, toggles, toggle assemblies and other components are depicted herein. Similar reference numbers are used to refer to similar component across the various embodiments. As described herein, references to a rear, rearward, or back end or surface of a component generally indicate the direction away from the user when switch 100 or other components are installed. In other words, the “rear” can be considered to be the direction toward the wall when switch 100 is installed in a wall. Further, references to a “front” or “forward” direction are intended to refer to the direction facing away from the wall toward the user when the switch is installed.

Switch 100 can comprise switch body 102. Switch body 102 can have form, dimensions, materials, and structure similar to conventional electrical switches capable of receiving rocker assembly 300. Switch body 102 can comprise two or more terminals 104 for connection to leads of an electrical circuit. Switch 100 can be a single-pole light switch including two terminals 104 for connection to electrical wiring. Embodiments of switch 100 can be three-way or four-way switches, and may include more terminals 104, including one or more grounding terminals in order to support environments in which multiple switches may control an electrical circuit.

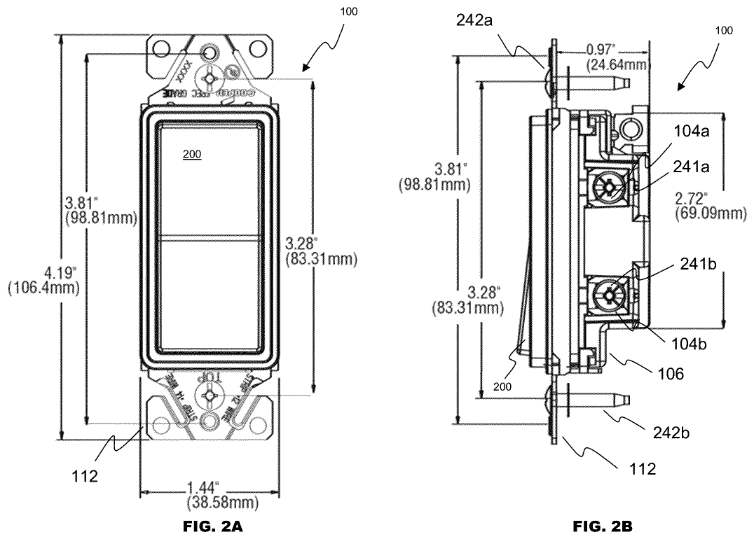

In the depicted embodiment of FIG. TA, switch body 102 comprises housing 106, contact assembly 108, guard plate 110, and mounting plate 112. In embodiments, guard plate 110 can further comprise pivot cradles 114. Switch body 102 can also have dimensions according to those depicted in FIGS. 2A and 2B. Those of ordinary skill in the art will appreciate that the configuration of switch body 102 depicted and described herein is a particular example, and various alternative configurations can be used, especially those adapted to applicable local electrical standards or codes.

In embodiments, housing 106 and mounting plate 112 are removably coupleable to other components by housing fasteners 241 and mounting fasteners 242, respectively. Housing fasteners 241a-c and mounting fasteners 242, depicted as 242a and 242b, can comprise screws, clips, nails, or other fastening mechanisms.

Rocker assembly 300 can comprise accessory board 236, light pipe 234, interchangeable label 304, and cover 214. Accessory board 236 can be a printed circuit board assembly (PCBA) comprising illuminating element 500. In embodiments, accessory board 236 can further comprise tactile switch 238. Interchangeable label 304 can comprise a label, sticker, decal, or other interchangeable decorative element. Interchangeable label 304 can be partially transparent or translucent. Label 304 can comprise one or more adhesive surfaces and be removable coupleable to light pipe 234 and/or cover 214. In other embodiments, label 304 can be simply arrangeable between light pipe 234 and cover 214 without further fixation. In an embodiment, one or any of label 304, cover 214, light pipe 234, or other components of rocker assembly 300 can comprise a ferromagnetic material, such that label 304 is magnetically affixable within rocker assembly 300.

Cover 214 can comprise a transparent or translucent material and be arrangeable proximate label 304 opposite from light pipe 234 when switch 100 is in use. Label 304 can therefore be arranged or sandwiched between cover 214 and light pipe 234. Cover 214 can comprise flanges, grooves, or other structures configured to slidably engage with light pipe 234.

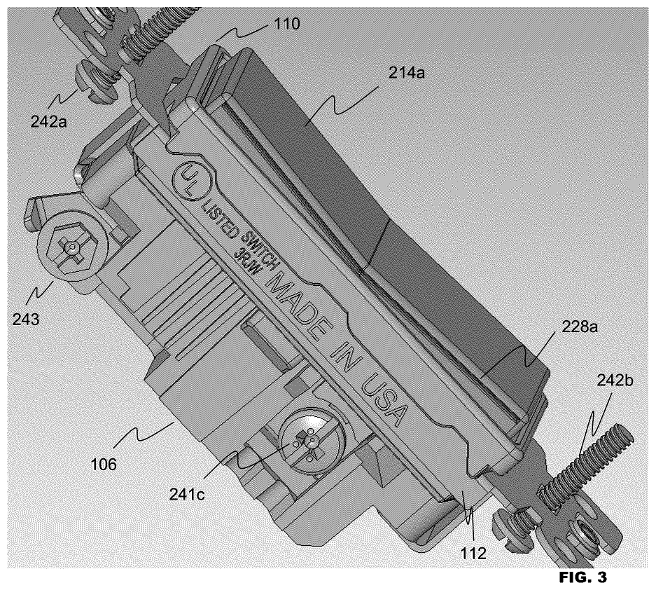

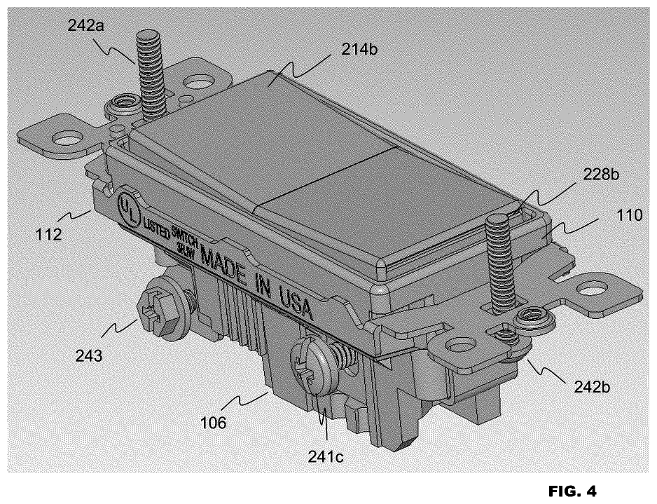

FIGS. 3 and 4 depict alternative embodiments wherein cover 214 further comprises slot 228. Slot 228 can be configured to enable insertion of label 304 into switch 100. FIG. 3 depicts slot 228 as side slot 228a. In FIG. 4, slot 228 is alternatively shown as bottom slot 228b. Slot 228 can be an elongated aperture defined by a top, bottom, side, or front surface of cover 214. Slot 228 can have at least one dimension, sufficient to enable insertion or removal of interchangeable label 304.

In embodiments, labels 304 can be substantially rectangular in shape. In embodiments, labels 304 can present one or more tabs, flanges, or other elements configured to protrude from slot 228 when label 304 is inserted within cover 214, to assist in the process of inserting, arranging, or removing label 304.

In embodiments, cover 214 can present a plurality of slots 228. For example, cover 214 can include a side slot 228a and a bottom slot 228b. Cover 214 can define multiple side slots, for example, a first slide slot on an upper portion of cover 214 and a second slide slot on a lower portion of cover 214. Other combination of slots can be defined by cover 214, to enable insertion or removal of a plurality of labels 308.

While not depicted, in embodiments cover 214 can define one or more internal compartments or chambers, each chamber arranged such that a label inserted through a slot 228 will be received and retained within the chamber until removed. For example, cover 214 can comprise an upper chamber with an upper slot and a lower chamber with a lower slot, such that discrete first and second labels 304 can be inserted.

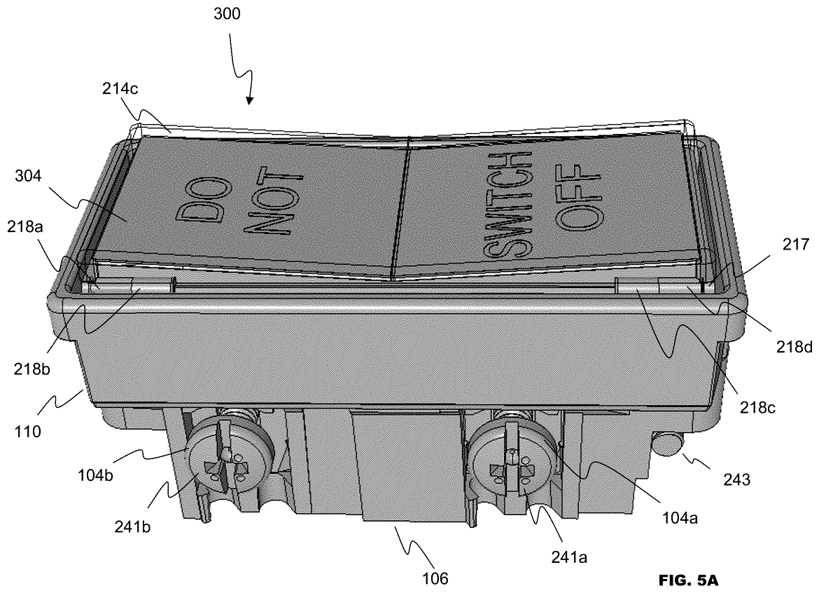

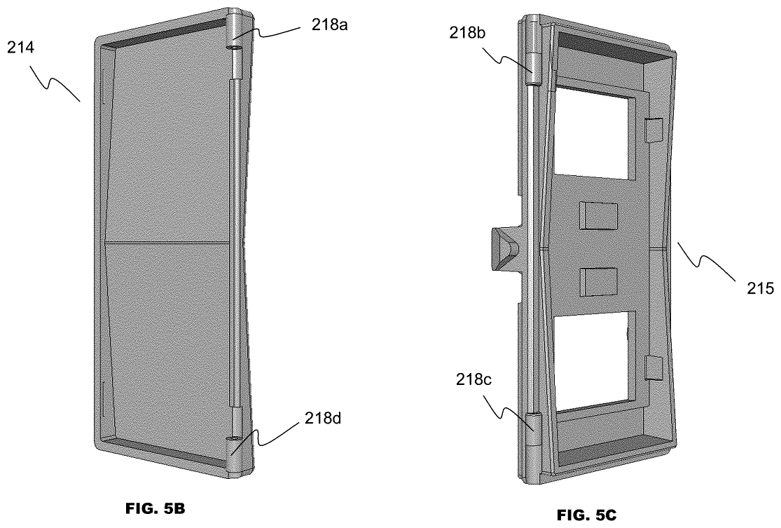

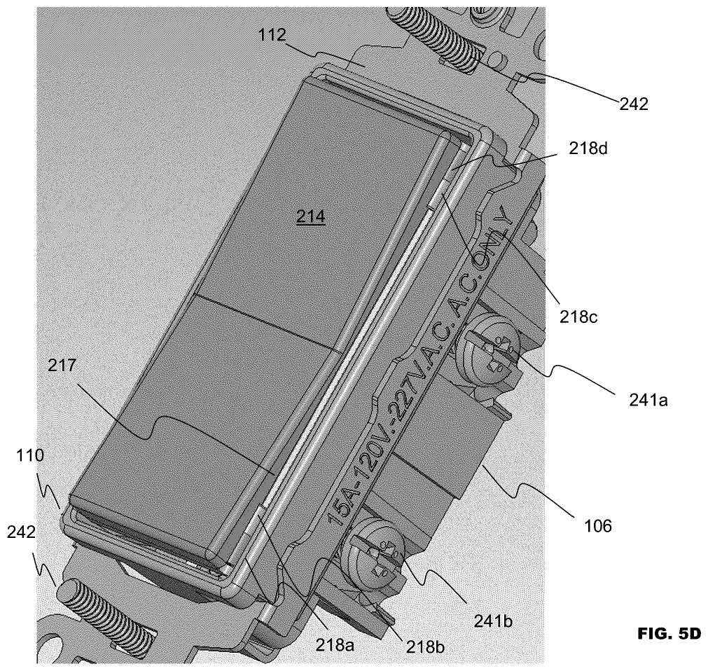

FIGS. 5A-5D shows an additional alternative embodiment. Rocker assembly 300 further optionally comprises cover base 215. Cover 214 and cover base 215 are assembled via hinge mechanism wherein pin 217 passes through cylindrical knuckles 218a-d of cover 214 and cover base 215. The hinge mechanism enables rotation of the cover 214 along the longitudinal axis of pin 217 and the placement of label 304 between the cover 214 and the cover base 215. The cover 214 and the cover base 215 may be translucent or transparent as in FIG. 5A or opaque as in FIG. 5C. While a barrel-and-pin style hinge is depicted and described, other hinge mechanisms, enabling rotation of cover 214 relative to switch body 102 are contemplated. Furthermore, in embodiments, knucks of cover base 215 can be optionally arranged on guard plate 110, such that cover base 215 is not provided.

Light pipe 234 can comprise a translucent or transparent material. In embodiments, light pipe 234 can comprise optical grade materials such as optical acrylic or polycarbonate. Light pipe 234 can be arranged proximate illuminating element 500 such that light emitted from illuminating element 500 can be transmitted to label 304 and cover 214. Light pipe 234 can comprise one or more flanges, grooves, slots, or other structures enabling cover 214 to be removably coupled to light pipe 234.

Rocker assembly 300 can comprise a plurality of accessory boards 236, such as accessory boards 236a and 236b as depicted. Each of accessory boards 236a and 236b can comprise illuminating element 500a and 500b, respectively. Rocker can comprise receivers 250a and 250b. Each receiver 250 can be comprised to removably engage a respective one of accessory board 236. Each of accessory boards 236a and 236b and illuminating elements 500a and 500b can have similar configurations and functionality as described above with respect to accessory board 236 and illuminating element 500b above. Light pipe 234 can be a singular unit, as depicted, or multiple light pipes 234 can be provided to separate light from illuminating elements 500a and 500b accordingly. Label 304 can similarly extend across light pipe 234, or comprise one or more separate labels 304, each including user-comprisable identifiers or other visual elements.

Accessory board 236 can draw power from an independent battery or other power source in embodiments. In embodiments, accessory board 236 can be electrically coupled to terminals 104 by one or more conductive traces (not shown) to draw power from the circuit controlled by switch. Accessory board 236 can comprise illuminating element 500 which can be a light-emitting diode (LED) or other light source capable of generating light without causing excess power draw or heating of switch 100. Illuminating element 500 can further comprise a circuit board including power terminals and LED.

In embodiments, illuminating element 500 can comprise a multi-element LED, such as the tri-color or red-green-blue (RGB) LEDs described in U.S. Pat. No. 8,339,058 to Simmers, or other light source capable of emitting light of various colors. In embodiments, illuminating element 500 can be factory configured to display a specific color.

In embodiments, switch 100 can include a configuration mechanism adapted to enable user selection of the color or intensity of illuminating element 500. In an embodiment, the configuration mechanism can comprise one or more switches, dials, or jumpers, enabling a user to determine whether illuminating element 500 will be illuminated, and if so the relative intensity of each element of a multi-element LED in order to determine the color. In an embodiment, the configuration mechanism can comprise a wired or wireless connection to a control device (such as a computer, mobile phone, table, remote control, or other device) adapted to send control signals that are interpreted by configuration mechanism to modify the operating parameters of illuminating element 500.

In embodiments, rocker assembly 300 can be constructed of hard plastic or other material suitable to allow operation of switch 100. Rocker assembly 300 can comprise a material that is temporarily or permanently markable with various substances including permanent ink, dry-erase ink, chalk, graphite, crayon, or other mark-making material. In embodiments, all or parts of rocker assembly 300 can be opaque, translucent, or transparent, in order to allow light emitted from illuminating element 500 to be seen through all or a portion of rocker assembly 300. Switch body 102 can be constructed of a variety of materials as are generally known in the art for the construction of electrical switches.

While switch 100 has been depicted and described as a rocker switch, in embodiments of the present disclosure switch 100 can be configured as a toggle switch, dimmer switch, push button switch, or other electrical switch configuration known in the art.

In embodiments, one or more switches 100 can be provided in a kit comprising multiple rocker assemblies 300 or labels 304, such that the label 304 displayed on switch 100 can be selected before or after the switch is installed. For example, in one embodiment, a kit can comprise a single switch 100, or rocker assembly 300, and multiple labels 304. In embodiments, a kit can comprise multiple switches arranged in a gang panel configuration (such as a one-, two-, three-, or higher gang switch) and multiple identifiers.

In embodiments, labels 304 can be provided in sets based on commonly grouped switch types. For example, a set can include identifiers for common household rooms such as kitchen, living room, dining room, and bedroom. Other sets can include identifiers for example, for overhead lights, floor lights, or audio appliances. Labels 304 can further be provided in sets corresponding to the alphabet of the English language (or other languages), Arabic numbers (1-10) or with a combination of colors, patterns, shapes or other designs.

In use, label 304 can provide an identifier related to the electrical circuit controlled by switch 100, such that the user can more easily distinguish the purpose of multiple switches 100 within a single area. Rocker assembly 300 can comprise a push button, such that illuminating element 500 is activated only after the user interacts with switch 100 by pushing rocker assembly 300.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. An electrical switch to control an electrical circuit comprising:
a switch body including a first terminal for electrical connection to a first lead of the electrical circuit and a second terminal for electrical connection to a second lead of the electrical circuit;
a rocker assembly including a rocker, a light pipe arrangeable proximate a rear surface of the rocker assembly, a cover arrangeable proximate a front surface of the rocker assembly, a slot on a surface of the cover for insertion of the interchangeable label between the light pipe and the cover;
an interchangeable label arrangeable proximate a rear surface of the rocker;
a light pipe arrangeable proximate a rear surface of the interchangeable label; wherein interchangeable label can be removably coupled to the light pipe via at least one adhesive surface;
a plurality of illuminating elements; wherein each of the plurality of illuminating elements comprises a tri-color light-emitting diode (LED);
wherein the rocker is pivotable between a first position and a second position such that the electrical circuit is energized when the rocker is in the first position and deenergized when the rocker is in the second position;
wherein the cover is couplable to the cover base through a hinge;
wherein the cover comprises a transparent material and is arrangeable proximate the interchangeable label the light pipe when the electrical switch is in use;
wherein the hinge comprises a pin and knuckles and arrangeable proximate a front surface of the interchangeable label;
wherein a controller having electrical communication with each of the illuminating elements is configured to change a display state of at least one illuminating element of the plurality of illuminating elements in response to a signal received via a communication interface and wherein the communication interface comprises a wireless interface;
wherein a conductive trace electrically couples each illuminating element of the plurality of the illuminating elements to the electrical circuit controlled by the electrical switch, such that the illuminating element is powered by the electrical circuit;
wherein a power source independent of the electrical circuit, such that the illuminating element is powered by the power source; and
wherein any element of the rocker assembly can comprise a ferromagnetic material such that the interchangeable label is magnetically affixable within the rocker assembly.

2. The electrical switch of claim 1 wherein the interchangeable label can comprise a label, sticker, decal, or other interchangeable decorative element and wherein the interchangeable label can be partially transparent or translucent.

3. The electrical switch of claim 1 wherein the interchangeable label can be removably coupled to the cover via at least one adhesive surface.

4. The electrical switch of claim 1 wherein changing the display state of the at least one illuminating element comprises one or more of:
changing a color of the at least one illuminating element,
changing a light intensity of the at least one illuminating element, or
changing a flash rate of the at least one illuminating element.

5. The electrical switch of claim 1 wherein the interchangeable label comprises a user-comprisable identifier on a front surface of the interchangeable label, such that the interchangeable label indicates a property of the electrical circuit controlled by the electrical switch.

6. The electrical switch of claim 1 wherein the interchangeable label at least partially comprises a light-transmitting material, such that a light generated by the illuminating element can be seen at a front surface of the interchangeable tile.

7. A kit for providing an indication of a function of an electrical switch, the kit comprising:
a plurality of interchangeable labels;
an electrical switch to control an electrical circuit comprising;
a switch body including a first terminal for electrical connection to a first lead of the electrical circuit and a second terminal for electrical connection to a second lead of the electrical circuit,
a rocker pivotable between a first position and a second position such that the electrical circuit is energized when the rocker is in the first position and deenergized when the rocker is in the second position, the rocker defining an aperture,
an illuminating element;
a cover arranged within the aperture such that a front surface of the cover is viewable by a user;
a light pipe, wherein each interchangeable label of the plurality of interchangeable labels is removably arrangeable between the cover and the light pipe; and
wherein each of the plurality of interchangeable labels comprises a user-comprisable identifier on a front surface of the interchangeable label such that the interchangeable label indicates a property of the electrical circuit controlled by the electrical switch.
